(19) United States
(12) Patent Application Publication
(10) Pub. No.: US 2006/0143576 A1
(43) Pub. Date: Jun. 29, 2006

(54) Method and system for resolving cross-modal references in user inputs

(76) Inventors: Anurag K. Gupta, Palatine, IL (US); Tasos Anastosakos, San Jose, CA (US)

Correspondence Address: MOTOROLA, INC., 1303 EAST ALGONQUIN ROAD, IL01/3RD, SCHAUMBURG, IL, 60196, US

(21) Appl. No.: 11/021,237

(22) Filed: Dec. 23, 2004

(51) Int. Cl. G10L 15/04

(52) U.S. Cl. 715/809; 704/251

(57) ABSTRACT

A method and a system for resolving cross-modal references in user inputs to a data processing system (100) are provided. The method includes generating (502) a set of multimodal interpretations (MMIs), based on the user inputs collected during a turn. The set of MMIs includes at least one reference, and each reference includes at least one reference variable. The method further includes generating (504) one or more sets of joint MMIs. Each set of joint MMIs includes MMIs of semantically compatible types. The method further includes generating (506) one or more sets of reference-resolved MMIs, by resolving the reference variables of the references contained in the sets of joint MMIs. The method further includes generating (508) an integrated MMI for each set of reference resolved MMIs. The generation of an integrated MMI is carried out by unifying the MMIs in a set of reference resolved MMIs.

### RELATED APPLICATION

This application is related to the following applications: Co-pending U.S. patent application Ser. No. 10/853,850, entitled “Method And Apparatus For Classifying And Ranking Interpretations For Multimodal Input Fusion”, filed on May 25, 2004, and Co-pending U.S. patent application Ser. No. ______ (Serial Number Unknown), entitled “Method and System for Integrating Multimodal Interpretations”, filed concurrently with this Application, both applications assigned to the assignee hereof.

### FIELD OF THE INVENTION

The present invention relates to the field of software and more specifically relates to reference resolution in multimodal user input.

### BACKGROUND

Dialog systems are systems that allow a user to interact with a data processing system to perform tasks such as retrieving information, conducting transactions, and other such problem solving tasks. A dialog system can use several modalities for interaction. Examples of modalities include speech, gesture, touch, handwriting, etc. User-data processing system interactions in the dialog systems are enhanced by employing multiple modalities. The dialog systems using multiple modalities for human-data processing system interaction are referred to as multimodal systems. The user interacts with a multimodal system using a dialog based user interface. A set of interactions of the user and the multimodal system is referred to as a dialog. Each interaction is referred to as a user turn of the dialog. The information provided by either the user or the multimodal system is referred to as a context of the dialog.

An important aspect of multimodal systems is the provision of cross-modal references, i.e., input in one modality referring to input provided in another modality. The number of cross-modal references in a user turn depends on various factors, such as the number of modalities, user-desired tasks and other system parameters. The number of cross-modal references in a user turn can be more than one. It is difficult to associate a reference made in a user input, entered by using one modality, to a referent in a user input entered by using another modality, in order to combine the inputs in different modalities. Further, the difficulty increases when multiple references and referents are present, and also when more than one referent can be associated with a single reference.

A known method for integrating multimodal interpretations (MMIs) based on unification performs single cross-modal reference resolution, i.e., the method is able to resolve references when the inputs for a user turn contain a single reference requiring a single referent. However, the method does not cater to inputs for a user turn that contain multiple references or when one or more references require more than one referent or when a reference requires the referents to satisfy certain constraints.

Another known method deals with integrating multimodal inputs that are related to a user-desired outcome and generating an integrated MMI in a multimodal system. However, the method does not work at a semantic fusion level, i.e., the multimodal inputs are not integrated semantically. Further, the implemented method does not allow the use of more than two modalities for entering user inputs in the multimodal system.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a system for implementing cross-modal reference resolution, in accordance with some embodiments of the present invention;

FIG. 2 illustrates an instance of a ‘Location’ concept represented as a multimodal feature structure (MMFS), in accordance with some embodiments of the present invention;

FIG. 3 is a representation of a concept within a domain model, in accordance with some embodiments of the present invention;

FIG. 4 illustrates an instance of a ‘CreateRoute’ task represented as a MMFS, in accordance with some embodiments of the present invention;

FIG. 5 is a representation of a task within a task model, in accordance with some embodiments of the present invention;

FIG. 6 is a flowchart illustrating a method for resolving cross-modal references, in accordance with some embodiments of the present invention;

FIG. 7 is a flowchart illustrating another method for resolving cross-modal references, in accordance with some embodiments of the present invention;

FIG. 8 is a flowchart illustrating yet another method for resolving cross-modal references, in accordance with some embodiments of the present invention;

FIG. 9 is a flowchart illustrating the process of reference resolution, in accordance with some embodiments of the present invention;

FIGS. 10 and 11 illustrate the process of building a reference association map, in accordance with some embodiments of the present invention;

FIGS. 12 and 13 depict a flowchart illustrating the process of adding a referent to a reference association structure, in accordance with some embodiments of the present invention;

FIGS. 14 and 15 depict a flowchart illustrating process of associating referents to a reference variable, in accordance with some embodiments of the present invention; and

FIG. 16 is a system for resolution of cross-modal references in user inputs, in accordance with an exemplary embodiment of the invention.

### DETAILED DESCRIPTION OF THE INVENTION

Before describing in detail the particular cross-modal reference resolution method and system in accordance with the present invention, it should be observed that the present invention resides primarily in combinations of method steps and system components related to cross-modal reference resolution technique.

Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

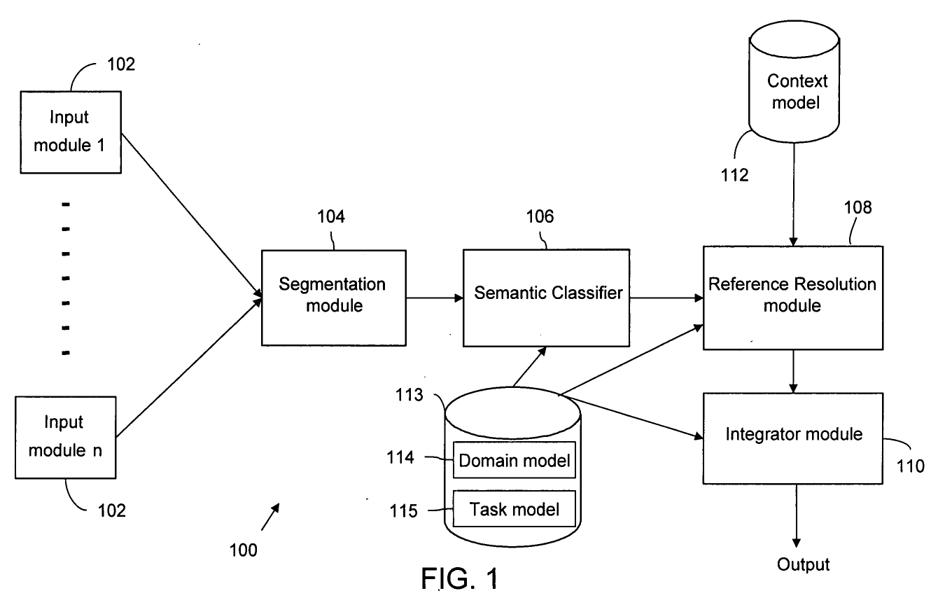

Referring to FIG. 1, a block diagram shows a data processing system 100 for implementing cross-modal reference resolution in accordance with some embodiments of the present invention. The data processing system 100 comprises at least one input module 102, a segmentation module 104, a semantic classifier 106, a reference resolution module 108, an integrator module 110, a context model 112, and a domain and task model 113. The domain and task model 113 comprises a domain model 114 and a task model 115. The segmentation module 104, the semantic classifier 106, reference resolution module 108, and integrator module 110 may collectively be referred to as a multimodal input fusion module, or MMIF module.

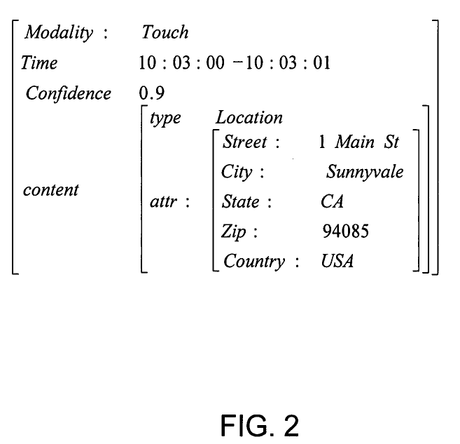

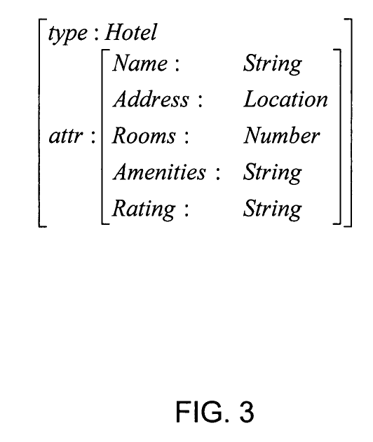

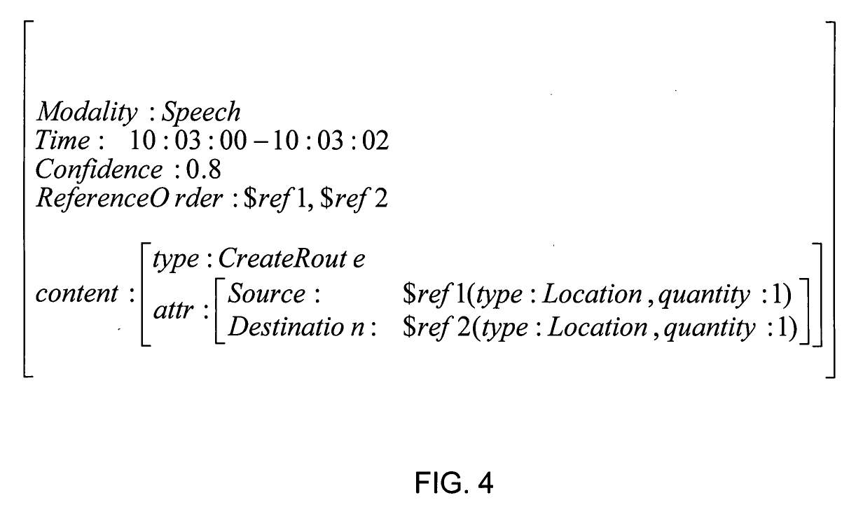

A user enters inputs through the input modules 102. Examples of the input module 102 include touch screens, keypads, microphones, and other such devices. A combination of these devices may also be used for entering the user inputs. Each user input is represented as a multimodal interpretation (MMI) that is generated by an input module 102. A MMI is an instance of either a concept or a task defined in the domain and task model 113. A MMI generated by an input module 102 can be either unambiguous (i.e. only one interpretation of user input is generated) or ambiguous (i.e. two or more interpretations are generated for the same user input). An unambiguous MMI is represented using a multimodal feature structure (MMFS). A MMFS contains semantic content and predefined attribute-value pairs such as name of the modality and the span of time during which the user provided the input that generated the MMI. The semantic content within an MMFS is a collection of attribute-value pairs, and relationships between attributes, domain concepts and tasks. For example, the semantic content of a ‘Location’ MMFS can have attributes like street name, city, state, zip code and country. The semantic content is represented as a Type Feature Structure (TFS) or as a combination of TFSs. The MMFS comprising a ‘Location’ TFS is further explained in conjunction with FIG. 2. Each attribute of a TFS can take values of pre-defined types, which can be one of either a basic type (string, number, date, etc.) or the type of another domain concept or task. This is explained in conjunction with FIG. 3 where the ‘Hotel’ concept contains three attributes (‘Name’, ‘Amenities’, and ‘Rating’) which take values of string type and contains an attribute (named ‘Address’) which takes values of ‘Location’ type (another domain concept). An ambiguous MMI is represented using two or more MMFSs (one MMFS for each interpretation of the same user input). Thus, an ambiguous MMI is like a collection of two or more MMIs such that during integration to generate an integrated MMI only one of them should be combined. Further, the MMIs generated for a single user turn comprise at least one reference, and each reference in turn, comprises at least one reference variable. In an embodiment of the invention, each reference variable refers to a value of an attribute that the reference variable is referencing within the MMI. Each reference variable comprises information about the number of referents required to resolve the reference variable. The number can be a positive integer or undefined (meaning the user did not specify a definite number for the number of required referents, e.g., when a user refers to something by saying “these”). Further, each reference variable comprises information about the type of referents required to resolve the reference variable. FIG. 4 shows a MMFS generated when a user of a navigation system says, “Create route from here to there”. The MMFS contains two reference variables, $ref1 and $ref2, for the expressions “here” and “there” respectively. Both ‘$ref1’ and ‘$ref2’ require a single referent of type ‘Location’. Further, each reference variable can contain constraints on referents that needed to be satisfied by a referent for the referent to be a resolved value of the reference variable. The constraints are expressed in the form of restrictions on the values of the attributes of the referents. For example, a reference variable requiring a referent of type ‘Location’ might contain a constraint that requires the zip code of the referent to be ‘60074’. In another example, a reference variable requiring a referent of type ‘Location’ might contain a constraint that requires the country of the referent to be one of ‘USA’ or ‘Canada’.

The MMIs based on the user inputs for a user turn are collected by the segmentation module 104. At the end of the user turn, the collected MMIs are sent to the semantic classifier 106. The semantic classifier 106 creates sets of joint MMIs, from the collected MMIs in the order in which they are received from the input module 102. Each set of joint MMIs comprises MMIs of semantically compatible types. Two MMIs are said to be semantically compatible if there exists a relationship between them, as defined in the taxonomy of the domain model 114 and task model 115. The relationships are explained in detail in later sections of the application.

The semantic classifier 106 divides the MMIs into sets of joint MMIs in the following way.

(1) If an MMI is unambiguous, i.e., there is only one MMI generated by an input module 102 for a particular user input, then either a new set of joint MMIs is generated or the MMI is classified into existing sets of joint MMIs. The new set of joint MMIs is generated if the MMI is not semantically compatible with any other MMIs in the existing sets of joint MMIs. If the MMI is semantically compatible to MMIs in one or more existing sets of joint MMIs, then it is added to each of those sets.

(2) If the MMI is ambiguous with one or more MMIs within the ambiguous MMI being semantically compatible to MMIs in one or more sets of joint MMIs, then each of the one or more MMIs in the ambiguous MMI is added to each set of the corresponding one or more sets of joint MMIs containing semantically compatible MMIs, using the following rules:
(a) If the set contains a MMI that is part of the ambiguous MMI, a new set is generated (which is a copy of the current set) and that MMI is replaced with the current MMI in the new set.
(b) If the set does not contain a MMI that is part of the ambiguous MMI, the current MMI is added to that set.

For each of the MMIs within the ambiguous MMI that are not semantically compatible with any existing set of joint MMIs, a new set of joint MMIs is created using the MMI.

(3) If none of the MMI in the ambiguous MMI is related to an existing set of joint MMIs, then for each MMI in the ambiguous MMI a new set of joint MMIs is created using the MMI.

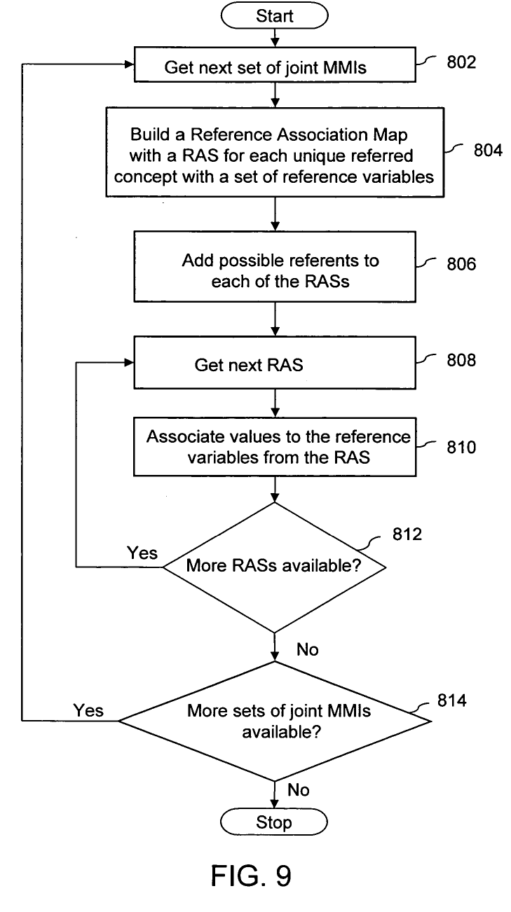

The sets of joint MMIs are then sent to the reference resolution module 108. The reference resolution module 108 generates one or more sets of reference-resolved MMIs by resolving the references present in the MMIs in the sets of joint MMIs. This is achieved by replacing the reference variables present in the references with a resolved value. In an embodiment of the invention, the resolved value is a bound value of the reference variable. The bound value of a reference variable is the semantic content of one or more MMIs (i.e. the TFSs) contained within the set of joint MMIs containing the MMI with the reference variable or the semantic content of one or more MMIs contained within the context model 112. The MMIs that are bound values of reference variables are removed from the set of joint MMIs to generate the set of reference-resolved MMIs. For example, if reference variable ‘$ref1’ in FIG. 4 requires a referent of type ‘Location’ is resolved with the ‘Location’ MMFS shown in FIG. 2 then the bound value is the semantic content (i.e. the TFS) contained within the MMFS shown in FIG. 2. In another embodiment of the invention, the resolved value is an unresolved operator (which signifies that the reference variable was not resolved) when the reference variable is not bound to any MMI. The process of reference resolution is further explained in conjunction with FIG. 9. The integrator module 110 then generates an integrated MMI for each set of reference-resolved MMIs by integrating the MMIs within the set of reference-resolved MMIs.

The context model 112 comprises knowledge pertaining to recent interactions between a user and the data processing system 100, information relating to resource availability and the environment, and any other application-specific information. The context model 112 provides knowledge about available modalities, and their status to an MMIF module. The context model 112 comprises four major components. These components are a modality model, input history, environment details, and a default database. The modality model component comprises information about the existing modalities within the data processing system 100. The capabilities of these modalities are expressed in the form of tasks or concepts that each input module 102 can recognize, the status of each of the input modules 102, and the recognition performance history of each of the input module 102. The input history component stores a time-sorted list of recent interpretations received by the MMIF module, for each user. This is used for determining anaphoric references. Anaphoric references are references that use a pronoun that refers to an antecedent. An example of anaphoric reference is, “Get information on the last two ‘hotels’”. In this example, the hotels are referred to anaphorically with the word ‘last’. The environment details component includes parameters that describe the surrounding environment of the data processing system 100. Examples of the parameters include noise level, location, and time. The values of these parameters are provided by external modules. For example, the external module can be a Global Position System that could provide the information about location. The default database component is a knowledge source that comprises information which is used to resolve certain references within a user input. For example, a user may enter an input by saying, “I want to go from here to there”, where the first ‘here’ in the sentence refers to the current location of the user and is not specified in the user input. The default database provides means to obtain to obtain the current location in the form of a TFS of type ‘Location’.

The domain model 114 is a collection of concepts within the data processing system 100, and is a representation of the data processing system 100's ontology. The concepts are entities that can be identified within the data processing system 100. The concepts are represented using TFSs. For example, a way of representing a ‘Hotel’ concept can be with five of its properties, i.e., name, address, rooms, amenities, and rating. The ‘hotel’ concept is further explained in conjunction with FIG. 4. The properties can be either of a basic type (string, number, date, etc.) or one of the concepts defined within the domain model 114. Further, the domain model 114 comprises a taxonomy that organizes concepts into sub-super-concept tree structures. In an embodiment of the invention, two forms of relationships are used to define the taxonomy. These are specialization relationships and partitive relationships. Specialization relationships, also known as ‘is a kind of’ relationship, describe concepts that are sub-concepts of other concepts. For example, an enzyme is a kind of protein, which, in turn, is a kind of macromolecule. The ‘is a kind of’ relationship implies inheritance, so that all the attributes of the super-concept are inherited by the sub-concept. Partitive relationships, also known as ‘is a part of’ relationship, describe concepts that are part of (i.e. components of) other concepts. For example, a ‘house’ concept can have a component of type ‘room’. The ‘is a part of’ relationship may be used to represent multiple instances of the same contained concept as different parts of the containing concept. Each instance of a contained concept has a unique descriptive name. Each instance defines a new attribute within the containing concept having the contained concept's type and the given unique descriptive name. For example, the components of a ‘house’ can be multiple ‘room’ concepts having unique descriptive names such as ‘master bedroom’, ‘corner bedroom’, etc.

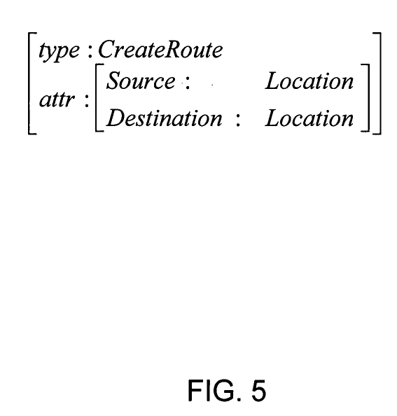

The task model 115 is a collection of tasks a user can perform while interacting with the data processing system 100 to achieve certain objectives. A task consists of a number of parameters that define the user data required for the completion of the task. The parameters can be either a basic type (string, number, date, etc.) or one of the concepts defined within the domain model 114 or one of the tasks defined in the task model 115. For example, the task of a navigation system to create a route from a source to a destination will have task parameters as ‘source’ and ‘destination’, which are instances of the ‘Location’ concept. The task model 115 contains an implied taxonomy by which each of the parameters of a task has ‘is a part of’ relationship with the task. The tasks are also represented using TFSs. The task model for the completion of the task of creating a route, named ‘Create Route’ task, is further explained in conjunction with FIG. 5.

Referring to FIG. 2, an MMI comprising a ‘Location’ concept represented as an MMFS is shown, in accordance with some embodiments of the present invention. The MMFS comprises details regarding input modality, duration of the user input, confidence level, and content of the user input. In an embodiment of the invention, the input modality is ‘touch’. The duration of the user input is from 10:03:00 to 10:03:01, which are the start and the end time, respectively, of the user input. The confidence level is 0.9 and semantic content is a ‘location’ concept. The confidence score is an estimate made by the input module 102 of the likelihood that the MMFS accurately captures the meaning of the user input. For example, these could very high for a keyboard input, but low for a voice input made in a noisy environment. These are not necessarily used in the embodiments of present invention described herein, or may be used in a manner not necessarily described herein. The ‘Location’ concept within the MMFS comprises the type of concept and the attributes of the concept. The attributes of the location concept are, for example, street name, city, state, zip code and country.

A single MMI may contain multiple reference variables. In MMIs with more than one reference variable, the references may be resolved in the order in which they were made by a user. Doing so helps to ensure that the correct referent is bound to the correct attribute. Therefore, a new feature is added by the present invention within a TFS in an MMI in the form of a reference order. The reference order is a list of the reference variables provided in the order in which the user specified them.

Referring to FIG. 4, a representation of a concept within a domain model is shown, in accordance with some embodiments of the present invention. A ‘hotel’ concept is described in the FIG. 4. The concept comprises the type of concept and the attributes of the concept. In an embodiment of the invention, the type of concept is ‘hotel’ and the attributes of the concept are, the name of the hotel, the address of the hotel, the number of rooms in the hotel, the amenities offered by the hotel, and the rating of the hotel.

Referring to FIG. 5, a representation of a task within a task model is shown, in accordance with some embodiments of the present invention. A ‘Create Route’ task corresponding to the user input is represented as a TFS. The task comprises the type of task and the attributes of the task. In an embodiment of the invention, the type of task is ‘CreateRoute’ and the attributes of the task are a source and a destination between which the route is to be created.

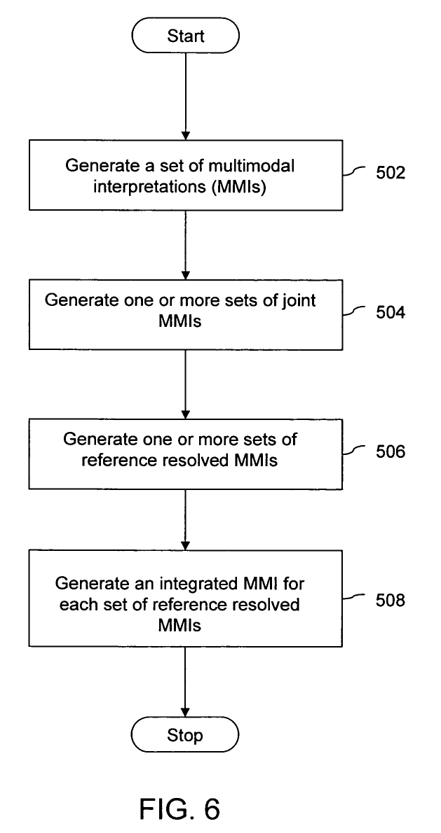

Referring to FIG. 6, a flowchart illustrates a method for resolving cross-modal references, in accordance with some embodiments of the present invention. At step 502, a set of MMIs, is generated, based on the user inputs collected during a user turn. Further, the MMIs comprising references are identified in each set of MMIs, One or more sets of joint MMIs are generated at step 504, using the set of MMIs generated at step 502. Each set of joint MMI comprises MMIs of semantically compatible types. Next, at step 506, one or more sets of reference resolved MMIs are generated by resolving the reference variables of references contained in the sets of joint MMIs. At step 508, an integrated MMI for each set of reference-resolved MMIs is generated by unifying the set of reference-resolved MMIs.

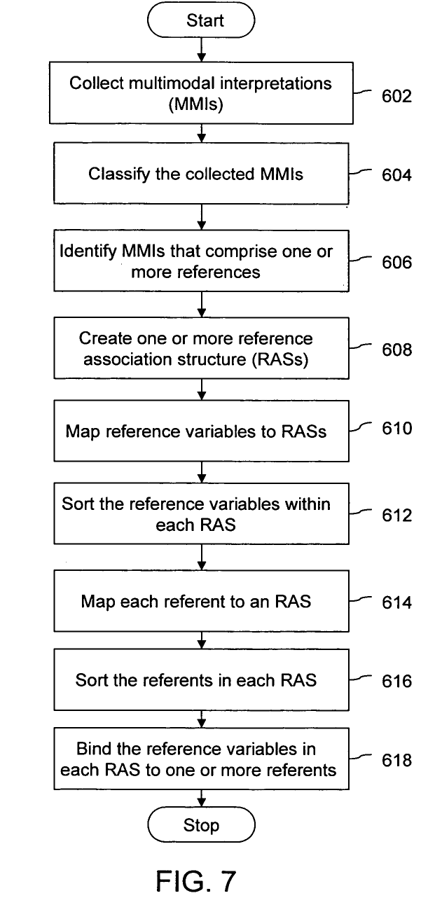

Referring to FIG. 7, a flowchart illustrates another method for resolving cross-modal references, in accordance with some embodiments of the present invention. The MMIs corresponding to user inputs for a user turn are collected at step 602. Each MMI has a time stamp associated with it. The time stamp comprises a start time and an end time specifying the duration of the user input in a user turn. The collected MMIs are classified into sets of semantically compatible MMIs at step 604. The steps 606 to 616 are then performed on each set of semantically compatible MMIs generated at step 604. At step 606, the MMIs that comprise one or more references are identified in a set of semantically compatible MMIs. At step 608, one reference association structures (RASs) is created for each unique type of MMI required by the reference variables contained within the identified MMIs. A RAS comprises reference variables and referents. The reference variables contained in a RAS require referents that have the same type or sub-type of the type of the RAS. The referents within a RAS have types that are either the same type or sub-type of the type of the RAS. The reference variables in the identified MMIs are then mapped on to the one or more RASs at step 610. The mapping is based on the type of MMI required by the reference variables. Next, at step 612, the reference variables within each RAS are sorted based on one or more pre-determined criteria. In an embodiment of the invention, a temporal order is put on each of the references within a user turn. Each possible referent, i.e. any MMI in the set of joint MMIs that does not have reference variables, is then mapped, at step 614, on to an RAS requiring referents that are of the same type or super-type of the referent. The referents in each RAS are then sorted, at step 616, using the one or more pre-determined criteria. In an embodiment of the invention, the referents and the reference variables are sorted based on the time stamps associated with each of them.

The reference variables in each RAS are then bound to one or more referents in the RAS at step 618. In an embodiment of the invention, binding a reference variable in each RAS to one or more referents in the RAS comprises associating a default referent with the reference variable. In an embodiment of the invention, the default referent is a pre-determined value. In another embodiment of the invention, the default referent is a value based on the state of the data processing system 100. For example, when the user of a navigation system, which is displaying a single hotel on a map, says, “I want to go to this hotel”, without making a gesture on the hotel, the default referent for reference variable is the hotel being displayed to the user. In another embodiment of the invention, the default referent is a value obtained from the input history component of the context model 112.

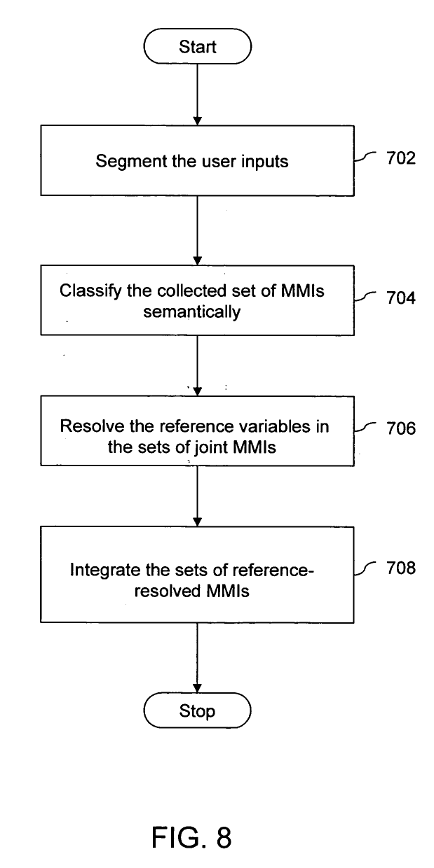

Referring to FIG. 8, a flowchart illustrates yet another method for resolving cross-modal references in user inputs to the data processing system 100, in accordance with some embodiments of the present invention. The user inputs to the data processing system 100 are segmented at step 702. Segmenting the user inputs comprises collecting a set of MMIs corresponding to the user inputs for a user turn. The collected set of MMIs is then classified semantically at step 704. Semantically classifying the collected set of MMIs comprises creating sets of joint MMIs. Each set of joint MMIs comprises MMIs from the collected set of MMIs that are of semantically compatible types. The reference variables in each set of joint MMIs are resolved at step 706. Resolving the reference variables comprises replacing each reference variable with a resolved value. The process of reference resolution is further explained in conjunction with FIG. 9. This generates a set of reference resolved MMIs for each set of joint MMIs. Next, at step 708, the sets of reference resolved MMIs are integrated to generate a corresponding set of integrated MMIs.

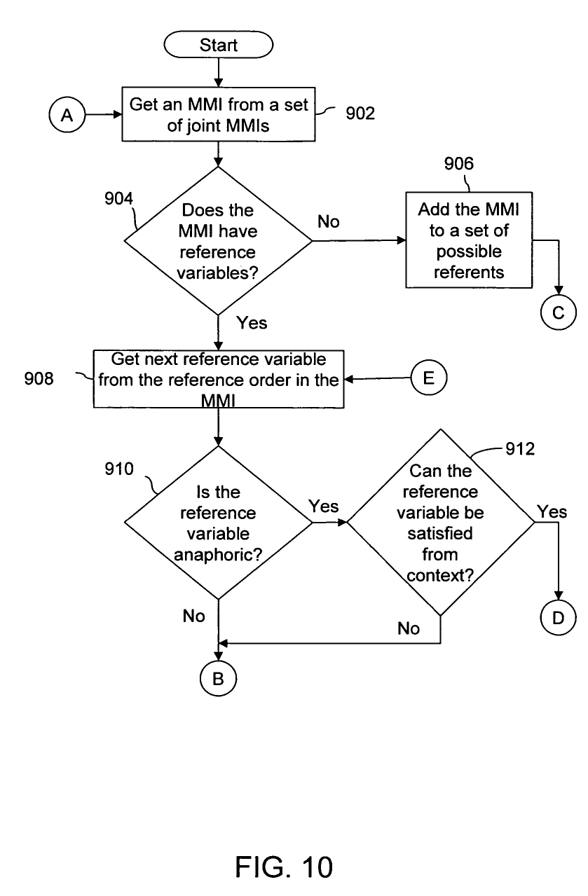

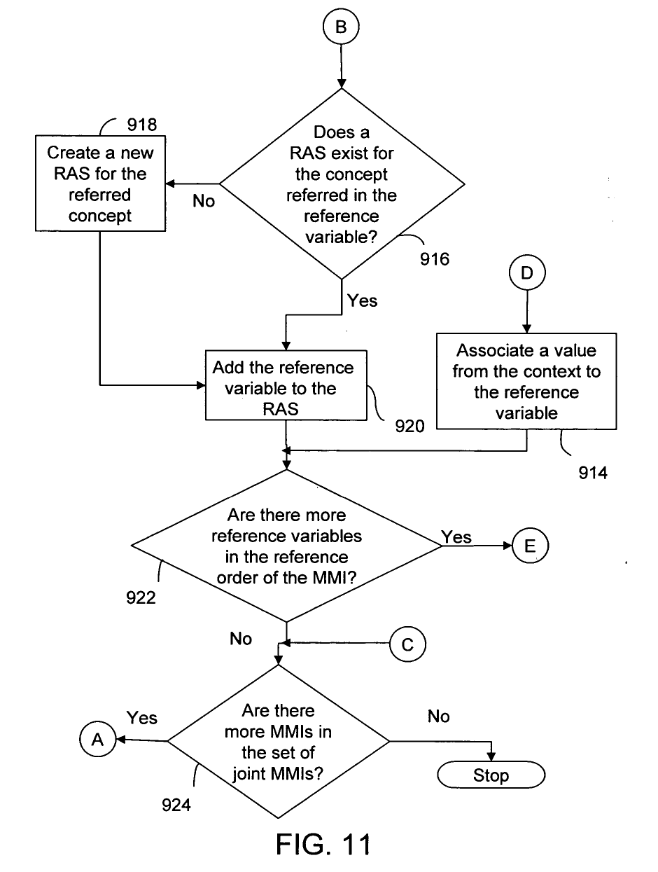

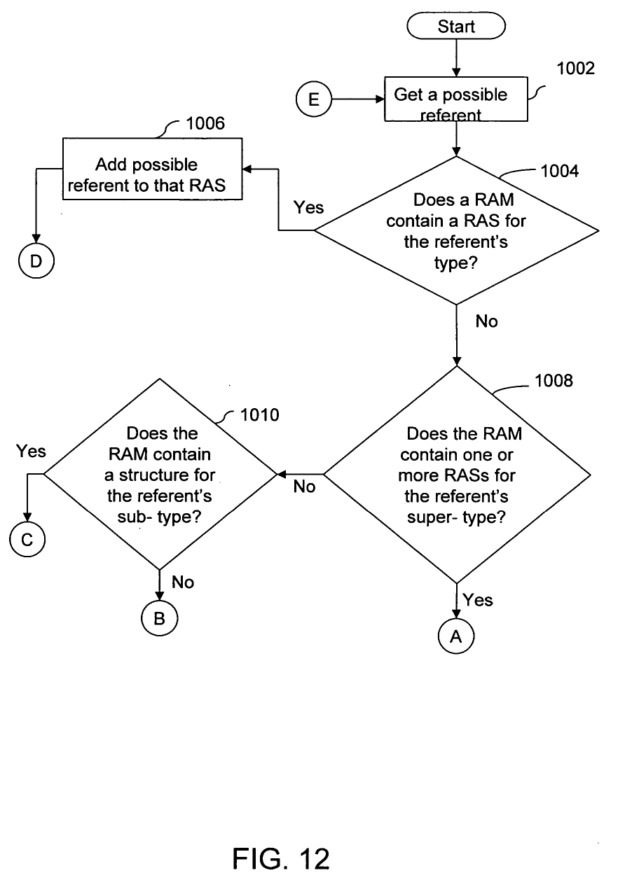

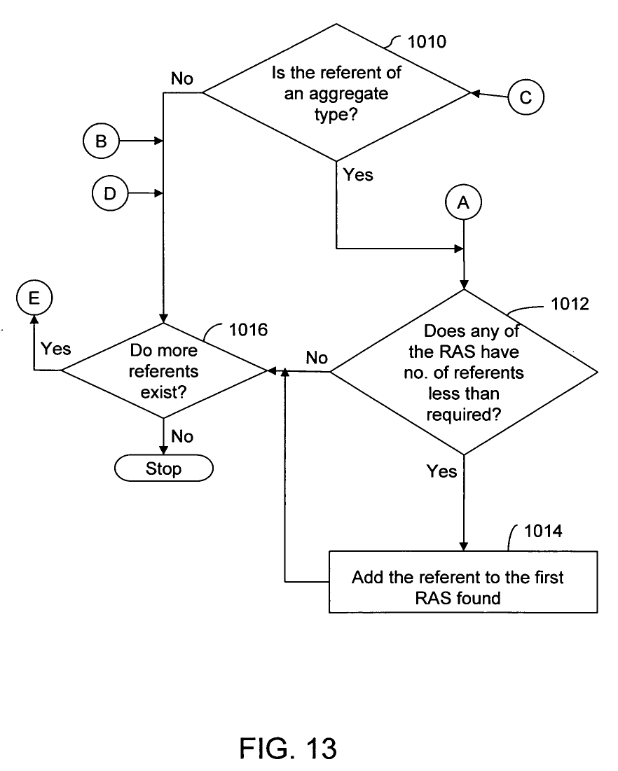

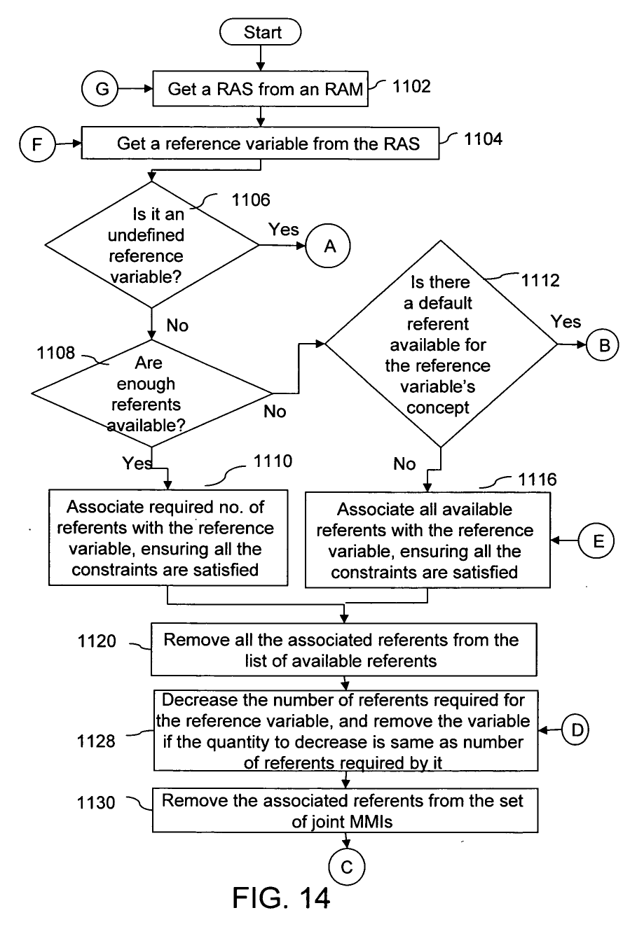

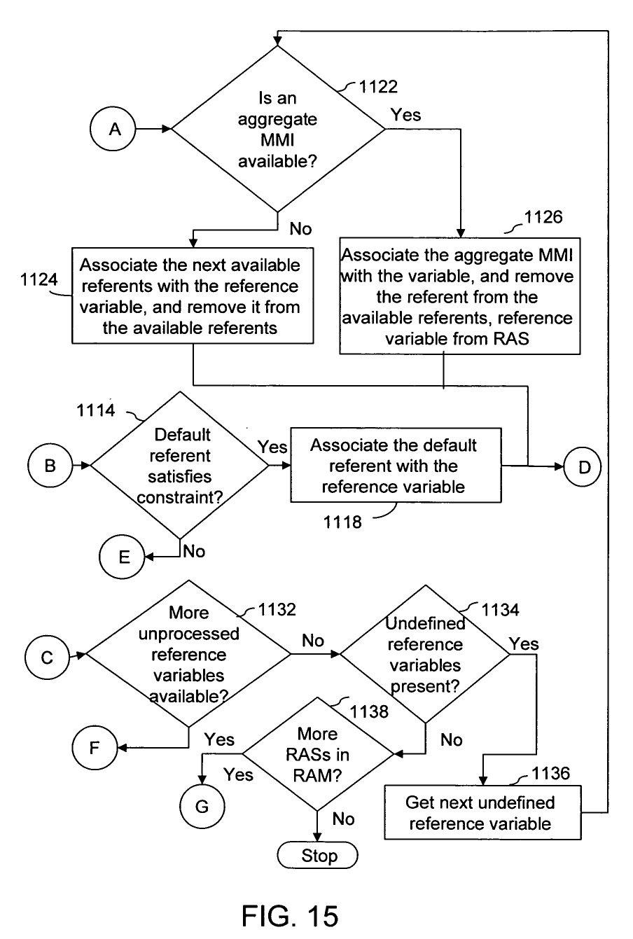

Referring to FIG. 9, a flowchart illustrates the process of reference resolution, in accordance with some embodiments of the present invention. First, a semantically classified set of joint MMIs is accessed at step 802. Next, at step 804, a reference association map (RAM) is built based on the set of joint MMIs. The RAM comprises at least one RAS corresponding to each unique type of MMI required to resolve the reference variables in the set of joint MMIs, and a set of reference variables corresponding to each RAS. The process of building a RAM is further explained in conjunction with FIG. 10 and FIG. 11. The referents, i.e. MMIs in the set of joint MMIs that do not have reference variables, are added to each of the RASs at step 806. The process of adding a referent to each of the RASs is further explained in conjunction with FIG. 12 and FIG. 13. Step 806 leads to each RAS in the set of joint MMIs containing at least one reference variable and zero or more referents. Then a RAS in the set of joint MMIs is accessed at step 808. Referents in the RAS are then associated with reference variables in that RAS, at step 810. The process of associating referents with a reference variable is further explained in conjunction with FIG. 14 and FIG. 15. At step 812, a check is carried out if more RASs are available in the set of joint MMIs. If more RASs are available, the steps 808 and 810 are repeated. However, if more RASs are not available, a check is carried out to determine whether more sets of joint MMIs are available, at step 814. If more sets of joint MMIs are available, the steps 802 to 814 are repeated.

Referring to FIGS. 10 and 11, two flowcharts illustrate the steps involved in building a RAM, in accordance with an exemplary embodiment of the invention. An MMI in the set of joint MMIs is accessed at step 902. A check is carried out, at step 904, if the MMI accessed at step 902 comprises any reference variables. If the MMI does not comprise a reference variable, the MMI is added to a set of possible referents at step 906. If the MMI comprises a reference variable, the next reference variable from the reference order in the MMI is accessed at step 908. Next, at step 910, it is determined whether the reference variable is anaphoric or deictic. A deictic variable is a variable that specifies identity, or spatial or temporal location from the perspective of a user. For example, if a user says, “I want to see these hotels”, it is a deictic reference to the hotels. If the reference variable is anaphoric, it is determined whether the reference variable can be resolved from a context in which it is used at step 912. Context model 112 can provide predetermined values for the reference variable or determine values for the reference variable based on the state of the data processing system, or based on user inputs acquired in one or more previous turns. For example, assume the user of a navigation system had gestured on a hotel in a previous turn. The MMI representing the hotel will be stored in the input history component of the context model 112. In the current turn the user says, “Show me the last hotel”. In this case, the anaphoric reference to the hotel is determined from the input history of the context model 112 which provides the MMI for the most recent hotel mentioned by the user (and stored in the input history) as the resolved value for the reference variable. At step 914, a value is associated with the reference variable from a context when the anaphoric reference variable can be satisfied from the context. If an anaphoric reference variable cannot be satisfied from a context or if the variable is deictic, a check is carried out to determine whether an RAS exists for the referred concept, at step 916. A new RAS is created for the concept for which an RAS does not exist, at step 918. The reference variable is then added to the RAS at step 920. A check is then made to determine if more reference variables are available from the reference order in the MMI, at step 922. If more reference variables are present, the steps 910 to 922 are repeated. A check is then made to determine whether more MMIs are present in the set of joint MMIs, at step 924. If more MMIs are present, the steps 902 to 924 are repeated.

Referring to FIGS. 12 and 13, two flowcharts illustrate the method of adding a referent to a reference association structure, in accordance with some embodiments of the present invention. A possible referent that maybe be added to an RAS is accessed at step 1002 from the set of possible referents created in step 906. A check is carried out to determine whether a RAM comprises an RAS of the possible referent's type, at step 1004. If an RAS that is of the same type as the referent exists in the RAM, the referent is added to that RAS at step 1006. If an RAS of the referent's type does not exist in the RAM, a check is carried out to determine whether an RAS for the referent's super-type exists, at step 1008. If an RAS of the referent's super-type does not exist, and if the referent is of an aggregate type, a check is carried out to determine whether an RAS for the referent's sub-type exists, at step 1010. An aggregate referent is an MMI that is generated when a user provides a number of concepts at the same time. For example, if in a multimodal navigation application, the user circles on the map to select a number of hotels and says, “Get info on these hotels”, then the MMI generated for the circling gesture is an aggregate over the interpretation of each hotel thus selected. Further, if either an RAS of the referent's sub-type exists and the referent is an aggregate type or an RAS of referent's super-type exists, another check is carried out to determine whether the number of available referents in an RAS is less than the number required by the referents in the RAS, at step 1012. If the number of available referents in an RAS is less than the required number of referents, the referent is added to the first such RAS found, at step 1014. At step 1016, a check is then made at to determine whether more referents, which can be added to an RAS, exist. If such referents exist, the steps 1002 to 1016 are repeated.

Referring to FIGS. 14 and 15, two flowcharts illustrate the steps involved in associating referents to a reference variable, in accordance with some embodiments of the present invention. An RAS contained in a RAM is accessed at step 1102. Then, a reference variable from the RAS is accessed at step 1104. A check is carried out at step 1106 if the reference variable requires an undefined number of referents. If the reference variable requires a well-defined number of referents, another check is carried out to determine whether enough referents are available in the RAS for associating with the reference variable, at step 1108. If the available referents are enough, the required referents are associated with the reference variable, ensuring that all the constraints on referents are satisfied, at step 1110. If the available referents are not enough, a check is carried out to determine whether a default referent is defined pertaining to the reference variable's concept, at step 1112. If a default referent is available, another check is carried out to determine whether the default referent satisfies all constraints on referents, at step 1114. If the default referent does not satisfy all the constraints on referents or if a default referent is not defined for the reference variable's concept, all the available referents are associated with the reference variable, ensuring that all the constraints on referents are satisfied, at step 1116. However, if at step 1114, the default referent satisfies all the constraints on referents, the default referent is associated with the reference variable at step 1118. After associating the required number of referents at step 1110, or the available referents at step 1116, all the associated referents are removed from the time-sorted list of available referents at step 1120.

However, if, at step 1106, the reference variable requires an undefined number of referents, a check is carried out at step 1122 to determine whether an aggregate MMI is available in list of available referents. If an aggregate MMI is available, it is associated with the reference variable at step 1124, and removed from the list of available referents. The reference variable is also removed from the RAS. On the other hand, if an aggregate MMI is not available, the next available referent is associated with the reference variable, at step 1126, and the referent is removed from the list of available referents. After removing the referents associated with the reference variable from the list of available referents in step 1120, or after associating the default referent with the reference variable in step 1118, the number of referents required by the reference variable is decreased by amount equal to the number of referents bound to the reference variable at step 1128. If the quantity decreased equals the number of referents required by a reference variable then the reference variable is removed from the RAS. The referents associated with a reference variable are then removed from the set of joint MMIs at step 1130. A check is then made, at step 1132, to determine whether more unprocessed reference variables (on whom the steps in FIG. 14 and FIG. 15 have not yet been carried out) are available in the RAS. If more reference variables are available, steps 1104 to 1132 are repeated. If more reference variables are not available, a check is carried out to determine whether any reference variables, which require undefined number of referents, are present in the RAS, at step 1134. If those reference variables are present, the next undefined reference variable is accessed at step 1136 and then the process follows the flowchart from step 1122 to associate remaining referents with those reference variables. However, if undefined reference variables are not present for the check in step 1134, a check is carried out to determine whether more RASs are present in the RAM, at step 1138. If more RASs are present, the steps 1102 to 1138 are repeated.

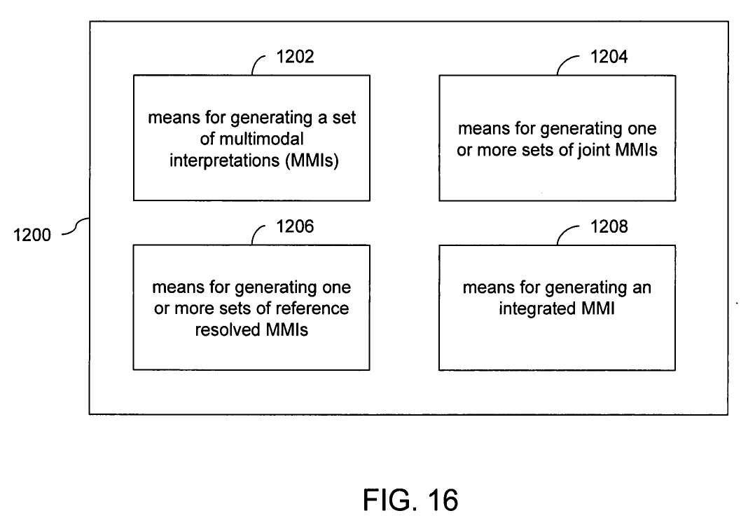

Referring to FIG. 16, an electronic device 1200 for resolution of cross modal references in user inputs in accordance with some embodiments of the present invention, is shown. The electronic device 1200 comprises a means for generating 1202 a set of MMIs based on the user inputs collected during a turn. Further the electronic device 1200 comprises a means for generating 1204 one or more sets of joint MMIs, based on the set of MMIs. Further, the electronic device 1200 comprises a means for generating 1206 one or more sets of reference resolved MMIs. The set of reference resolved MMIs is generated by resolving the reference variables of references in the one or more sets of joint MMIs. The electronic device 1200 also comprises a means for generating 1208 an integrated MMI for each set of reference-resolved MMIs. The integrated MMI is generated by unifying the set of reference-resolved MMIs.

The multimodal reference resolution technique as described herein can be included in complicated systems, for example a vehicular driver advocacy system, or such seemingly simpler consumer products ranging from portable music players to automobiles; or military products such as command stations and communication control systems; and commercial equipment ranging from extremely complicated computers to robots to simple pieces of test equipment, just to name some types and classes of electronic equipment.

It will be appreciated the cross-modal reference resolution technique described herein may be comprised of one or more conventional processors and unique stored program instructions that control the one or more processors to implement some, most, or all of the functions described herein; as such, the functions of generating a set of MMIs and generating one or more sets of reference resolved MMIs may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

A “set” as used herein, means an empty or non-empty set. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for resolving cross-modal references in user inputs to a data processing system, the user inputs being entered through at least one input modality, the method comprising:
generating a set of multimodal interpretations (MMIs) based on the user inputs collected during a turn, at least one MMI comprising at least one reference, each reference comprising at least one reference variable;
generating one or more sets of joint MMIs, each set of joint MMIs comprising MMIs of semantically compatible types;
generating one or more sets of reference resolved MMIs by resolving reference variables of references of the one or more sets of joint MMIs; and
generating an integrated MMI for each set of reference resolved MMIs, wherein the generation of the integrated MMI is done by unifying the set of reference resolved MMIs.

2. The method in accordance with claim 1 further comprising:
generating a type feature structure for each MMI in the set of MMIs; and
identifying the MMIs comprising references from the set of MMIs.

3. The method in accordance with claim 1 wherein resolving the reference variables of references within one or more sets of joint MMIs comprises:
creating one or more reference association structures (RASs), one RAS for each different type of MMI referred to by at least one reference variable of the references within the one set of joint MMIs;
mapping the reference variables of the references within the one set of joint MMIs to the one or more RASs, the mapping being based on the type of MMI required by the reference variable;
sorting the reference variables in each RAS using one or more pre-determined criteria;
mapping each referent, which is an MMI that does not include reference variables, of the one set of joint MMIs to an RAS that has the same type or super-type as the referent;
sorting the referents in each RAS using the one or more pre-determined criteria; and
binding the reference variables in each RAS to one or more referents in the RAS.

4. The method in accordance with claim 3 wherein binding the reference variables in each RAS to one or more referents is done after satisfying any constraints on referents contained in the reference variable.

5. The method in accordance with claim 3 wherein binding referents to the reference variables in each RAS to one or more referents in the RAS comprises associating an aggregate referent with the reference variables.

6. The method in accordance with claim 3 wherein binding referents to the reference variables in each RAS to one or more referents in the RAS comprises associating an unresolved operator with each of one or more reference variables in the RAS when the one or more reference variables are not bound to any referents in the RAS.

7. The method in accordance with claim 3 wherein binding referents to the reference variables in each RAS to one or more referents in the RAS comprises associating a default referent with a reference variable.

8. The method in accordance with claim 5 wherein a default referent is one of a pre-determined value and a value based on the state of the data processing system.

9. The method in accordance with claim 1 wherein a temporal order is put on each of the references within a user turn.

10. The method in accordance with claim 1 wherein each MMI has a time stamp associated with the MMI, the time stamp comprising a start time and an end time of the user input corresponding to the MMI.

11. The method in accordance with claim 10 wherein the reference variables and the referents in the RAS are sorted based on their time stamps.

12. The method in accordance with claim 1 wherein each reference variable comprises information about the type of the referents required to resolve the reference variable.

13. The method in accordance with claim 12 wherein each reference variable refers to a value of an attribute within an MMI that the reference variable is referencing.

14. The method in accordance with claim 12 wherein each reference variable further comprises information about the number of referents required to resolve the reference variable.

15. The method in accordance with claim 12 wherein at least one reference variable further comprises constraints on referents that need to be satisfied by a referent to be bound to the reference variable.

16. A method for resolving cross-modal references in user inputs to a data processing system, the user inputs being entered through at least one input modality, the data processing system generating references based on each user input, each reference comprising at least one reference variable, the method comprising:
collecting multimodal interpretations (MMIs) corresponding to the user inputs for a user turn;
classifying the collected MMIs into one or more sets of semantically compatible MMIs;
identifying MMIs that comprise one or more references in each of the one or more sets of semantically compatible MMIs;
creating one or more reference association structures (RASs) for each set of semantically compatible MMIs, one RAS for each unique type of MMI required to resolve the references in the identified MMIs with the set of semantically compatible MMIs;
mapping the reference variables of the references in the identified MMIs of a set of semantically compatible MMIs to the one or more RASs contained in that set of semantically compatible MMIs, the mapping being based on the type of MMI required by the reference variable;
sorting the reference variables within each RAS using one or more pre-determined criteria;
mapping each referent, which is an MMI that does not have reference variables, of a set of semantically compatible MMIs to an RAS contained in the set of semantically compatible MMIs requiring referents that are of the same type or super type as the referent;
sorting the referents in each RAS using the one or more pre-determined criteria; and
binding the reference variables in each RAS to one or more referents in the RAS.

17. A method for resolving cross-modal references in user inputs to a data processing system, the user inputs being entered through at least one input modality, the data processing system generating references based on each user input, each reference comprising at least one reference variable, the method comprising:
segmenting the user inputs, wherein the segmenting comprises collecting a set of multimodal interpretations (MMIs) corresponding to the user inputs for a user turn;
classifying the collected set of MMIs semantically, wherein semantically classifying the collected set of MMIs comprises creating sets of joint MMIs, each set of joint MMIs comprising MMIs of semantically compatible types;
resolving the reference variables in the sets of joint MMIs to create corresponding sets of reference-resolved MMIs, wherein resolving the reference variables comprises replacing each reference variable with a resolved value; and
integrating the set of reference-resolved MMIs to generate a corresponding set of integrated MMIs.

18. The method in accordance with claim 17 wherein resolving the reference variables comprises:
accessing each set of joint MMIs corresponding to each set of collected and classified MMIs;
building a reference association map, the reference association map comprising at least one RAS corresponding to each unique type of MMI required to resolve the reference variables in the set of joint MMIs and a set of referents corresponding to each RAS;
adding referents to each of the RASs; and
associating referents in the at least one RAS with reference variables in that RAS.

19. The method in accordance with claim 18 wherein building a reference association map comprises:
accessing MMIs in each set of joint MMIs;
adding an accessed MMI to the set of referents if the MMI does not comprise reference variables;
determining whether each reference variable, from an ordered list of reference variables in an accessed MMI, is anaphoric or deictic;
associating a value with a reference variable based on a context, when the reference variable is anaphoric, the context being determined by user inputs acquired in one or more previous turns;
adding a reference variable to the at least one RAS having the same type as the MMI required to satisfy the reference variable when the reference variable is deictic, or when the reference variable is an anaphoric value that cannot be resolved from the context.

20. An electronic equipment that resolves cross-modal references in user inputs to a data processing system, the user inputs being entered through at least one input modality, the equipment comprising:
means for generating a set of multimodal interpretations (MMIs) based on the user inputs collected during a turn, at least one MMI comprising at least one reference, each reference comprising at least one reference variable;
means for generating one or more sets of joint MMIs, each set of joint MMIs comprising MMIs of semantically compatible types;
means for generating a set of reference resolved MMIs for each set of joint MMIs, wherein the generation of the set of reference resolved MMIs is done by resolving reference variables of the references of the set of joint MMIs; and
means for generating an integrated MMI for each set of reference resolved MMIs, wherein the generation of the integrated MMI is done by unifying the set of reference resolved MMIs.

21. A computer program product for use with a computer, the computer program product comprising a computer usable medium having a computer readable program code embodied therein for resolving cross-modal references in user inputs to a data processing system, the user inputs being entered through at least one input modality, the computer program code performing:
generating a set of multimodal interpretations (MMIs) based on the user inputs collected during a turn, at least one MMI comprising at least one reference, each reference comprising at least one reference variable;
generating one or more sets of joint MMIs, each set of joint MMIs comprising MMIs of semantically compatible types;
generating a set of reference resolved MMIs for each set of joint MMIs, wherein the generation of a set of reference resolved MMIs is done by resolving the reference variables of the references of the set of joint MMIs; and
generating an integrated MMI for each set of reference resolved MMIs, wherein the generation of the integrated MMI is done by unifying the set of reference resolved MMIs.
